(19) United States
(12) Patent Application Publication
(10) Pub. No.: US 2016/0247223 A1
(43) Pub. Date: Aug. 25, 2016

(54) Fully Automated Consumer-Facing Mortgage Processing Systems, Processes Methods and Products

(71) Applicant: Michael Arnall, Los Angeles, CA (US)

(72) Inventor: Michael Arnall, Los Angeles, CA (US)

(21) Appl. No.: 15/042,477

(22) Filed: Feb. 12, 2016

Related U.S. Application Data
(60) Provisional application No. 62/115,711, filed on Feb. 13, 2015.

(51) Int. Cl. G06Q 40/02; G06Q 50/16

(52) U.S. Cl. CPC G06Q 40/025; G06Q 50/16

(57) ABSTRACT

A fully automated consumer-facing mortgage platform and processing systems for providing consumers with control over material aspects of the mortgage process from the front end to the back end, as well as providing enhanced visibility into all areas of the mortgage process, thereby streamlining the mortgage process and improving consumer experience. Processes, methods and products feature tools and functions to enhance the user-friendly experience for consumers.

### CROSS REFERENCE TO RELATED APPLICATIONS

This application claims the benefit of, and priority to, U.S. Provisional Patent Application Ser. No. 62/115,711, filed Feb. 13, 2015, the content of which is incorporated herein by reference herein in its entirety.

This invention relates generally to loan processing systems, and, more particularly, to an automated consumer-facing mortgage processing system for providing a consumer with control over most of the mortgage process, as well as providing enhanced visibility into all areas of the mortgage process, thereby streamlining the mortgage process and improving consumer experience.

### BACKGROUND OF THE INVENTION

In the mortgage industry, consumer (e.g., potential borrowers) are either seeking a loan for a home purchase, such as a first home, second home, etc. or investment property, or they are attempting to refinance an existing loan for real estate that they have previously financed or they own. The typical mortgage process consists of three general elements: the origination system; the pricing engine; and the automated underwriting system. All three elements play an integral role in the mortgage decision-making process.

The loan origination system (LOS) is generally utilized by the lender to gather data from the consumer for eventual submission to an underwriter as well as an automated underwriting system. The loan application is contained within the loan origination system along with a plethora of forms and data fields used by lenders to qualify borrowers for mortgages. All departments may be able to communicate via the loan origination system in an effort centralize all communications. One current loan origination system includes, for example, Encompass®, offered by Ellie Mae®.

The pricing engine is an integration of both pricing and qualification. The various pricing engines in the market today aggregate data from investors and government sponsored enterprises to determine if certain loan parameters meet certain investor guidelines. In the event that loan parameters meet the investor guidelines, the pricing engine responds with pricing for the respective scenarios. Mortgage loan originators and lenders utilize the pricing engine as a tool to price out specific borrower loan applications. Some current examples of pricing engines include, for example, Optimal Blue®, Encompass Product and Pricing Service, and PriceMyLoan.

After the loan originator or lender receives a borrower's information and enters it into the loan origination system, the application is submitted to the approval engine by the underwriter via an automated underwriting system. Although some companies have their own proprietary systems, the ones most often used are Fannie Mae's Desktop Underwriter (DU) and Freddie Mac's Loan Prospector (LP). These automated systems calculate qualification using many different factors contained in the loan application, including, but not limited to, assets, income, credit, and property information.

In most instances, the mortgage process includes a variety of different actors acting on behalf of the lender, including, but not limited to, mortgage brokers, mortgage bankers, loan officers, loan originators, and the like. Accordingly, most of the mortgage loan process is carried out on the lender's end, while the consumer (potential borrower) merely provides all of the required information. Accordingly, the consumer's only interaction with any of the three aforementioned elements of the mortgage process occurs through several layers of lender employees. For example, the consumer speaks to the mortgage loan originator who gathers all the data and distributes the data into the lender's loan origination system. In many instances, one employee enters data into the loan origination system, one employee prices the loan, and yet another employee submits the data to the underwriter for submission to the automated underwriting engine.

As such, all of the major transactions of the mortgage process generally occur outside of the consumer's purview, as they are non-consumer-facing, which can be problematic and particularly frustrating for the consumer. For example, the current mortgage process can be fraught with inconsistencies, human error, intentional consumer loan fraud, and complete consumer mistrust of the mortgage process in general and the professionals within the industry. Although obtaining a mortgage should be relatively straightforward, the mortgage process can be complex and rather confusing for the consumer, due in large part to the wide variety of products and programs being offered by the lenders, as well as inept professionals in the industry that may be presenting offers to the consumer without the consumer's best interest in mind.

### BRIEF SUMMARY OF THE INVENTION

The present invention relates to an automated consumer-facing mortgage processing system for providing a consumer with control over most of the mortgage process from the front end to the back end, as well as providing enhanced visibility into all areas of the mortgage process, thereby streamlining the mortgage process and improving consumer experience. In the embodiments described herein, the system is configured to empower the consumer by providing a consumer with the ability to direct and drive the mortgage process on their own, with lithe or no intervention. In effect, the system of the present invention all but eliminates many of the tasks and fees commonly associated with employing the services of mortgage brokers, mortgage bankers, loan officers, loan originators, and the like.

Generally, the system is configured to provide a platform or interface with which a consumer may interact to direct and drive the mortgage application process from the initial stages of the process (e.g., initial application) through loan approval and eventual closing on a property. The system is configured to provide an intuitive data collection process, in which the consumer is walked through the different aspects of the application process. The system prompts the consumer to provide informational data from the consumer that is generally required when applying for a mortgage, including, but not limited to, personal information (name, date of birth, social security number, address, basic information to verify identity, etc.), income, assets, employment information, details related to the property to be purchased or the current property to be refinanced, and additional information as required. The system provides a consumer with the ability to enter the requested information at their leisure and at their own pace. The system further allows a consumer to save their progress for any given application and revisit the saved application (which includes all of the previously input data) so as to continue the loan application process at the convenience.

The system further includes measures configured to ensure that certain data provided by the consumer is accurate and verified prior to submission of a mortgage loan application pricing and underwriting. For example, in some embodiments, the system is configured to integrate verification services. For example, a consumer's current address can be verified by the United States Postal Service (USPS), specifically an address information application programming interface (API) integrated into the system, such as USPS Web Tools® Address Information API. The details related the current property owned or related to the property to be purchased can be verified by a real estate API, such as one offered by Zillow, for example. The details may include, among other things, the estimated value of the property, which a consumer may rely on when deciding the mortgage amount. Similarly, a consumer's income and employment information (e.g., W-2s, bank statements, etc.) may be verified by any known methods, most commonly the Income Verification Express Service program provided by the IRS. The system may be configured to securely store return data from the IRS and compare such return data with the income and/or employment data so as to verify that the consumer inputted data matches and can be verified.

Upon receiving all of the required information from the consumer, the system is configured to run a full credit report, generally by utilizing the credit reporting services of common national consumer credit reporting agencies (e.g., Experian, Equifax, and TransUnion). The consumer is able to obtain their credit report and credit scores immediately, with little or no delay, as opposed to the conventional method in which the credit score would be sent (by mail or email) to the consumer from the lender. With the credit history and median credit score, the system is configured to utilize an integrated pricing service to calculate and generate various rates, prices, term options based on the various information provided in the mortgage application and the consumer's credit report. The system is able to provide the loan pricing options directly to the consumer, such that the consumer has clear visibility as to all available options of the mortgage they are seeking. At this point, the consumer is able to review all of the parameters of each loan option and select which one is best suited for their situation.

When ready, the consumer has the option of submitting the complete loan application for approval. The system is configured to transmit all of the relevant information provided in the mortgage application, the consumer's credit report, and the selected loan option to an integrated automated underwriting service, such as Fannie Mae's Desktop Underwriter (DU). At this point, the consumer is able to view the status of their loan application in real-time for subsequent approval or disapproval. Although most of the mortgage process is carried out from the consumer's perspective, the system of the present invention utilizes services on the lender's end. For example, from a lender's perspective, the system is configured to generate and transmit a file containing all information associated with the submitted loan application into a loan originating service associated with the lender. At which point, conditions may be automatically populated in the loan originating service allowing the underwriter to review the application and provide approval or disapproval.

The system may generally be embodied on any known internet-based computing system, or other external computing configuration in which there are one or more remote servers networked to allow a centralized data storage and online access to such data. For example, in one embodiment, the system may be embodied on a cloud-based service, for example, and provide an interface such that one or more consumers, lenders, or other users may access the system and interact with the interface so as to direct the mortgage application process.

Accordingly, a system consistent with the present disclosure provides numerous advantages. For example, the system described herein eliminates many of the unnecessary roles, responsibilities, and tasks normally performed by the mortgage broker, loan officer, or other actors from the mortgage process while giving complete control of the mortgage transaction to the consumer. In some instances, by providing more control to the consumer, the system may eliminate the inherent conflicts of interest between the mortgage professionals and the consumer, thus saving consumers fees associated with the mortgage, such as closing costs, by eliminating broker fees, origination fees, yield spread, and junk fees, while also expediting the mortgage loan closing process. Furthermore, by providing much of the control in the hands of the consumer, a consumer has increased visibility, thereby improving the entire mortgage process, which may otherwise be frustrating for some due to lack of transparency with the conventional mortgage process.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment or an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### BRIEF DESCRIPTION OF THE DRAWINGS

FIG. 1 is a block diagram illustrating one embodiment of an exemplary automated consumer-facing mortgage processing system.

FIG. 2 is a block diagram illustrating the automated consumer-facing mortgage processing system of FIG. 1 in greater detail.

FIG. 3 is a block diagram illustrating the system of FIG. 2 in greater detail.

FIG. 4 is a block diagram illustrating the receipt of a mortgage loan request from a consumer, collection of data required for the mortgage process approval, verification/validation of the mortgage loan application data, and evaluation of a submitted mortgage loan application to provide a consumer with approval/disapproval of the mortgage loan.

FIGS. 5A and 5B are a continuous flowchart of example operations consistent with at least one embodiment of the present disclosure.

FIG. 6 is a screenshot of a home screen dashboard provided by the system interface from which a consumer may navigate various options related to a new or existing mortgage loan application.

FIGS. 7-12 are screenshots of the interface provided by the system illustrating various steps in a mortgage loan application process in which a consumer is guided through various steps for providing and/or obtaining informational data required for the eventual approval process.

FIG. 13 is a screenshot of the interface provided by the system illustrating the direct delivery of various rates, prices, and term options for specified mortgage loan parameters, calculated by an integrated pricing service and based, at least in part, on the informational data provided in the mortgage loan application

FIG. 14 is a screenshot of the interface provided by the system illustrating a mortgage loan overview upon submission of a mortgage loan application to an integrated underwriter service.

FIG. 15 is a screenshot of the interface provided by the system illustrating an overview of an approved mortgage loan summarizing the more common and relevant terms of the mortgage loan.

FIG. 16 is a screenshot of the home screen dashboard provided by the system interface illustrating the ability of a consumer to view particular aspects of an existing mortgage loan application.

FIGS. 17-19 are screenshots of the dashboard illustrating various options related to viewing the particular aspects of an existing mortgage loan application, including the status of the application, document management providing upload capabilities, and a contact page for providing contact information for a member of the lender assigned to the particular mortgage loan application.

### DETAILED DESCRIPTION OF THE INVENTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment. It should be noted that the “consumer” and “borrower” are used interchangeably throughout this specification and should be treated as having similar meaning with respect to the subject matter of the present disclosure.

By way of overview, the present invention is generally directed to an automated consumer-facing mortgage processing system for providing a consumer with control over most of the mortgage process from the front end to the back end. In the embodiments described herein, the system is configured to empower the consumer by providing a consumer with the ability to direct and drive the mortgage process on their own, with little or no intervention. In effect, the system of the present invention all but eliminates many of the tasks and fees commonly associated with employing the services of mortgage brokers, mortgage bankers, loan officers, loan originators, and the like.

For the purposes of discussion, the following description is primarily focused on applying the system to the mortgage process. However, it should be noted that a system consistent with the present disclosure can be applicable in other lending scenarios, such as typical loans and the like, and is not limited to mortgages. Furthermore, the system is configured to allow the consumer to have access to other services typically handled by the lender, including, but not limited to, escrow and closing services, title companies, appraisal companies, insurance agencies, and the like. As such, a system consistent with the present disclosure may provide a marketplace whereby borrowers can select all their own services, in addition to driving the mortgage process.

Generally, the system is configured to provide a platform or interface with which a consumer may interact to direct and drive the mortgage application process from the initial stages of the process (e.g., initial application) through loan approval and eventual closing on a property. The system may generally be embodied on any known internet-based computing system, or other external computing configuration in which there are one or more remote servers networked to allow a centralized data storage and online access to such data. For example, in one embodiment, the system may be embodied on a cloud-based service, for example, and provide an interface such that one or more consumers, lenders, or other users may access the system and interact with the interface so as to direct the mortgage application process.

The system is configured to provide an intuitive data collection process, in which the consumer is walked through the different aspects of the application process. The system prompts the consumer to provide informational data from the consumer that is generally required when applying for a mortgage, including, but not limited to, personal information (name, date of birth, social security number, address, basic information to verify identity, etc.), income, assets, employment information, details related to the property to be purchased or the current property to be refinanced, and additional information as required. The system provides a consumer with the ability to enter the requested information at their leisure and at their own pace. The system further allows a consumer to save their progress for any given application and revisit the saved application (which includes all of the previously input data) so as to continue the loan application process at the convenience.

The system further includes measures configured to ensure that certain data provided by the consumer is accurate and verified prior to submission of a mortgage loan application pricing and underwriting. For example, in some embodiments, the system is configured to integrate verification services. For example, a consumer's current address can be verified by the United States Postal Service (USPS), specifically an address information application programming interface (API) integrated into the system, such as USPS Web Tools® Address Information API. The details related the current property owned or related to the property to be purchased can be verified by a real estate API, such as one offered by Zillow, for example. The details may include, among other things, the estimated value of the property, which a consumer may rely on when deciding the mortgage amount. Similarly, a consumer's income and employment information (e.g., W-2s, bank statements, etc.) may be verified by any known methods, most commonly the Income Verification Express Service program provided by the IRS. The system may be configured to securely store return data from the IRS and compare such return data with the income and/or employment data so as to verify that the consumer inputted data matches and can be verified.

Upon receiving all of the required information from the consumer, the system is configured to run a full credit report, generally by utilizing the credit reporting services of common national consumer credit reporting agencies (e.g., Experian, Equifax, and TransUnion). The consumer is able to obtain their credit report and credit scores immediately, with little or no delay, as opposed to the conventional method in which the credit score would be sent (by mail or email) to the consumer from the lender. With the credit history and median credit score, the system is configured to utilize an integrated pricing service to calculate and generate various rates, prices, term options based on the various information provided in the mortgage application and the consumer's credit report. The system is able to provide the loan pricing options directly to the consumer, such that the consumer has clear visibility as to all available options of the mortgage they are seeking. At this point, the consumer is able to review all of the parameters of each loan option and select which one is best suited for their situation.

When ready, the consumer has the option of submitting the complete loan application for approval. The system is configured to transmit all of the relevant information provided in the mortgage application, the consumers credit report, and the selected loan option to an integrated automated underwriting service, such as Fannie Mae's Desktop Underwriter (DU). At this point, the consumer is able to view the status Of their loan application in real-time for subsequent approval or disapproval. Although most of the mortgage process is earned out from the consumers perspective, the system of the present invention utilizes services on the lender's end. For example, from a lender's perspective, the system is configured to generate and transmit a file containing all information associated with the submitted loan application into a loan originating service associated with the lender. At which point, conditions may be automatically populated in the loan originating service allowing the underwriter to review the application and provide approval or disapproval.

Accordingly, a system consistent with the present disclosure provides numerous advantages. For example, the system described herein eliminates many of the unnecessary roles, responsibilities, and tasks normally performed by the mortgage broker, loan officer, or other actors from the mortgage process while giving complete control of the mortgage transaction to the consumer. In some instances, by providing more control to the consumer, the system may eliminate the inherent conflicts of interest between the mortgage professionals and the consumer, thus saving consumers fees associated with the mortgage, such as closing costs, by eliminating broker fees, origination fees, yield spread, and junk fees, while also expediting the mortgage loan closing process. Furthermore, by providing much of the control in the hands of the consumer, a consumer has increased visibility, thereby improving the entire mortgage process, which may otherwise be frustrating for some due to lack of transparency with the conventional mortgage process. Additionally, a system consistent with the present invention may be used as a stand-alone platform or may be interfaced with lenders that have licensing rights to incorporate the system into their business structure.

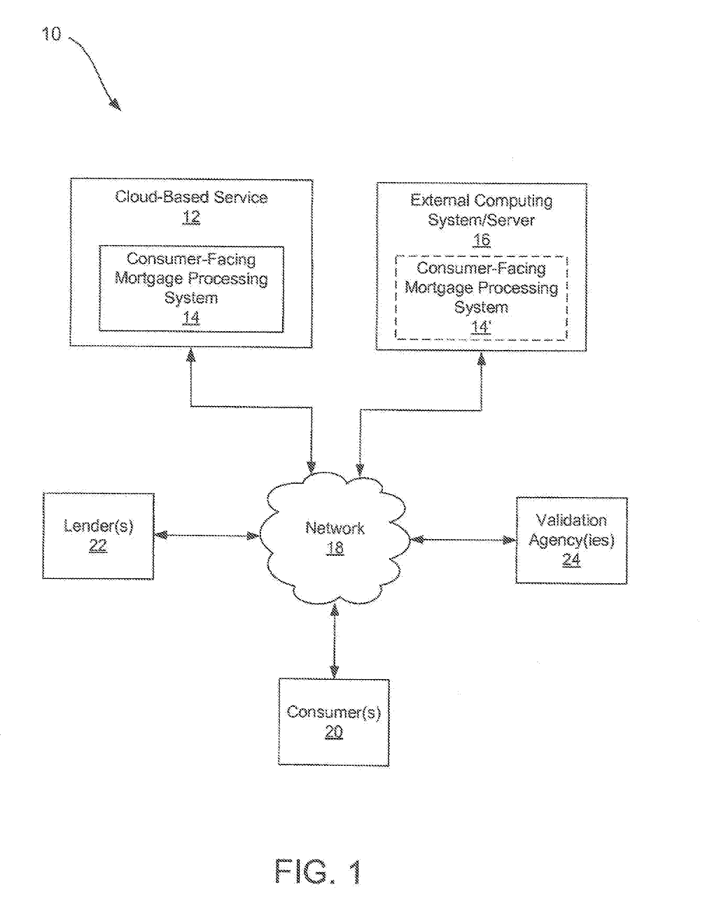

FIG. 1 is a block diagram illustrating one embodiment of an exemplary system 10 for providing consumer-facing loan processing. The term “consumer-facing” (also known as “customer facing”), as used herein, generally refers to the manner in which a service is experienced or seen by a consumer. For example, the system described herein may generally include hardware, software or technology with user interfaces (UI) or applications that directly interact with the consumer.

As shown, the system 10 includes a cloud-based service 12 configured to communicate and share data with one or more consumers 20, one or more lenders 22, and one or more validation agencies 24 over a network 18. As shown, the cloud-based service 12 may include an automated consumer-facing mortgage processing system 14 consistent with the present disclosure. As described in greater detail herein, the automated consumer-facing mortgage processing system 14 is configured to provide an interface in which a consumer 20 can control most of the mortgage process from the front end to the back end. In the embodiments described herein, the system 14 is configured to empower the consumer 20 by providing a consumer 20 with the ability to direct and drive the mortgage process on their own, with little or no intervention. In effect, the system 14 of the present invention all but eliminates many of the tasks and fees commonly associated with employing the services of mortgage brokers, mortgage bankers, loan officers, loan originators, and the like.

In the illustrated embodiment, the system 14 is embodied in the cloud-based service 12. However, it should be noted that the system 14 may be embodied in an external computing system/server 16, as indicated by consumer-facing mortgage processing system 14′. In any event, the system 14 may be accessed by any one of the consumers 20, lenders 22, and validation agencies 24 via the network 18.

As previously described, the system 14 may be embodied on the cloud-based service 12 and be accessed by and share data between a consumer 20, a tender 22, and a validation agency 24 via the network 18. The network 18 may be any network that carries data. Non-limiting examples of suitable networks that may be used as network 18 include Wi-Fi wireless data communication technology, the internet, private networks, virtual private networks (VPN), public switch telephone networks (PSTN), integrated services digital networks (ISDN), digital subscriber link networks (DSL), various second generation (2G), third generation (3G), fourth generation (4G) cellular-based data communication technologies, Bluetooth radio, Near Field Communication (NFC), other networks capable of carrying data, and combinations thereof. In some embodiments, network 16 is chosen from the internet, at least one wireless network, at least one cellular telephone network, and combinations thereof. As such, the network 18 may include any number of additional devices, such as additional computers, routers, and switches, to facilitate communications. In some embodiments, the network 18 may be or include a single network, and in other embodiments the network 18 may be or include a collection of networks.

Accordingly, at least one of consumers 20, lenders 22, and validation agencies 24 may be able to access and share data with the automated consumer-facing mortgage processing system 14 via any computing device capable of communicating with the cloud-based service 12 and/or other computing devices over the network 18. For example, the computing device may be embodied as, without limitation, a computer, a desktop computer, a personal computer (PC), a tablet computer, a laptop computer, a notebook computer, a mobile computing device, a smart phone, a cellular telephone, a handset, a messaging device, a work station, a distributed computing system, a multiprocessor system, a processor-based system, and/or any other computing device configured to store and access data, and/or to execute software and related applications consistent with the present disclosure.

As generally understood, the consumer 20 may include any person in the market looking for a mortgage or loan in general. The lender 22 may include any financial institution looking to provide mortgage consultation, mortgage services, including initial mortgage loan, and the like. The validation agencies 24, as will be described in greater detail herein, general relate to agencies able to provide services for validating certain types of information required for the mortgage loan process, such as, for example, the IRS when validation a consumer's income.

As described in greater detail herein, the automated consumer-facing mortgage processing system 14 is configured to provide a platform or interface in which a consumer 20 can control most of the mortgage process from the front or to the back end. As generally understood, the platform or interface is generally in the form of an interface (e.g., but not limited to graphical user interface (GUI)) provided on a computing device through which a consumer may interact with the system 14, such as accessing and interacting with the mortgage loan process provided by the system 14.

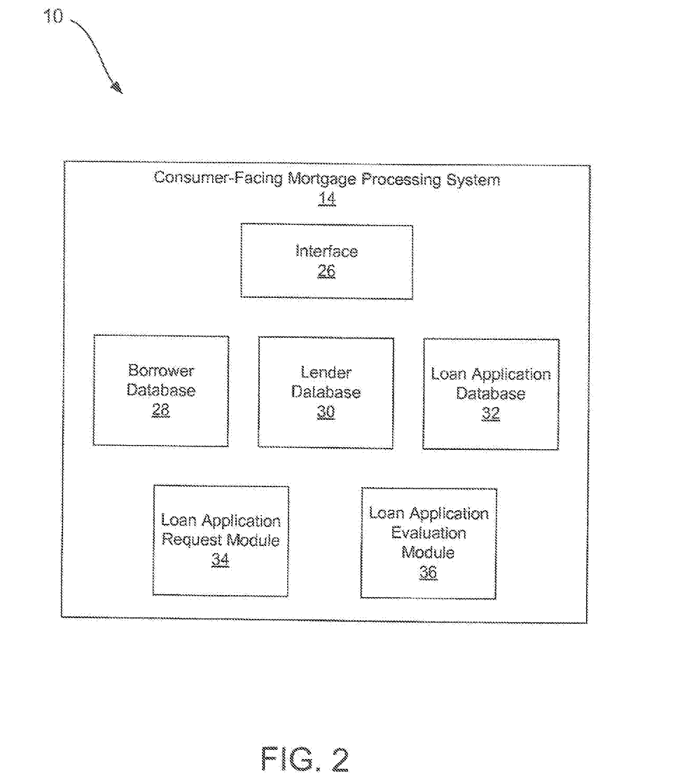

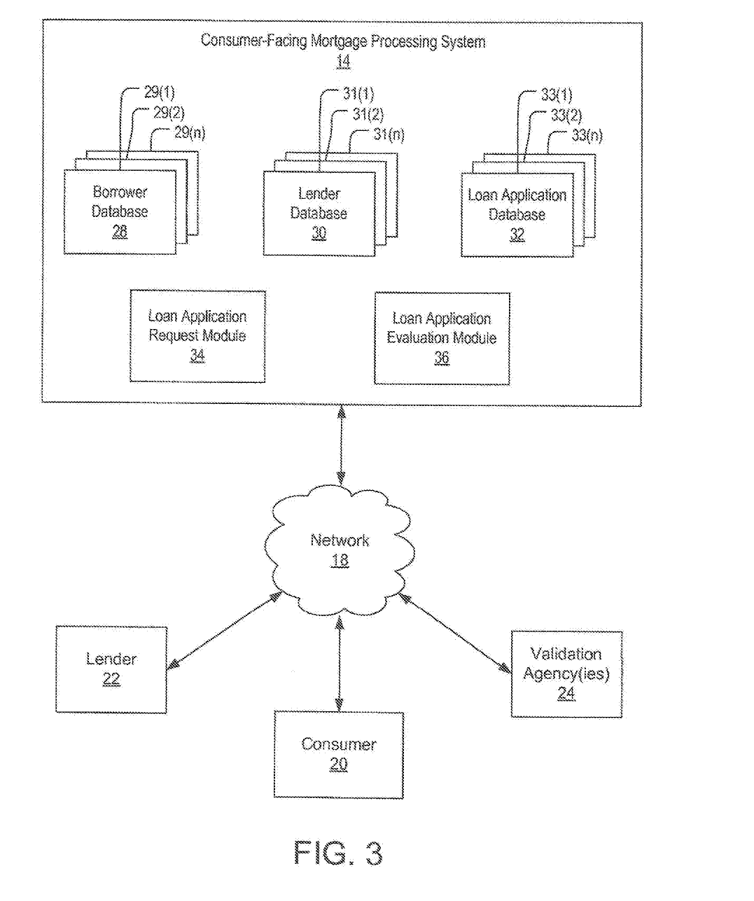

FIGS. 2 and 3 are block diagrams illustrating the automated consumer-facing mortgage processing system 14 of FIG. 1 in greater detail. As shown, the system 14 includes an interface 26, a borrower (consumer) database 28, a lender database 30, a loan application database 32, a loan application request module 34, and a loan application evaluation module 38. The interface 26 may generally allow at least the consumer 20 to access and share data with one or more components of the system 14.

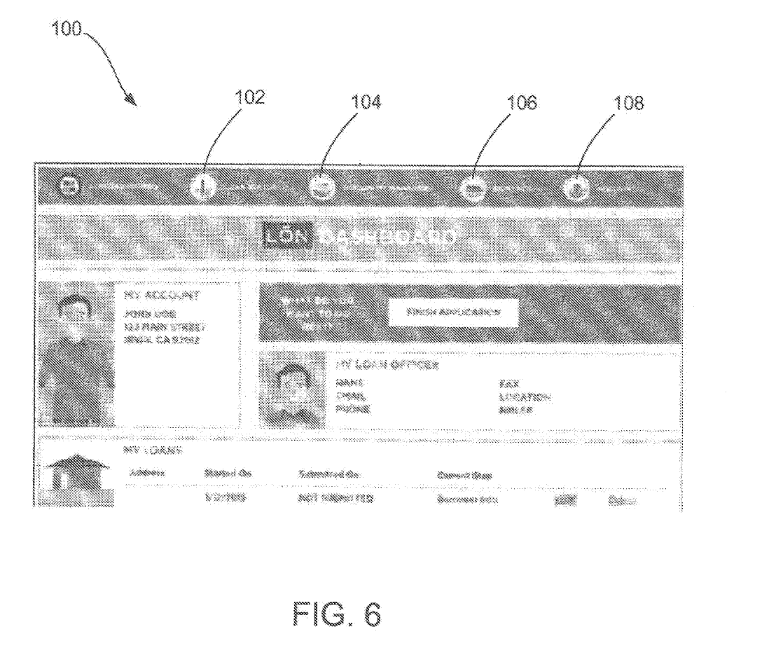

For example, upon accessing the system 14 on the cloud-based service 12, the interface 26 may allow a consumer 20 to navigate a dashboard (shown in FIG. 6, for example) and either start a new loan application, view and continue working on an existing loan application stored within the loan application database 32, or view the status and/or other details associated with a completed and submitted loan application stored within the loan application database 32. The interface 26 may further allow a consumer 20 to access data related to one a many lenders that may have an account with the system 14 and offer loan services.

As an initial step, however, a consumer 20 may first be provided with access to a borrower database 28 so as to create or login to an existing profile or account (profiles 29(1)-29(n)). As will be described in greater detail herein, each borrower profile may include conventional input (e.g., name, address, billing information, background information, preferences, login credentials, etc.). The consumer 20 may further have access, via the interface 26, to the loan application database 32 so as to either view and continue working on an existing loan application (loan applications 33(1)-33(n)) stored within the loan application database 32, or view the status and/or other details associated with a completed and submitted loan application stored within the loan application database 32. In some instances, lenders 22 may have access to the system 14, specifically the lender database 30 so as to create or login to an existing profile or account (profiles 31(1)-31(n)). Each lender profile may include conventional input (e.g., name, address, background information, preferences, services provided, etc.). It should be noted, however, that the lender 22 will generally have limited to access to components of the system 14 so as to ensure the security of a consumers personal information, as well as loan information is kept strictly confidential and private, unless a lender 22 is given express authority to have access to any such information.

As will be described in greater detail herein, the loan application request module 34 is configured to allow a consumer 20 to request initiation of a new loan application or allow a consumer to continue working on an existing loan application. Upon generating a validated loan application based on information provided by the consumer 20 (consumer-driven process), the validated loan application data is then provided to the loan application evaluation/status module 36, which is subsequently configured to provide such data to the proper integrated service(s) (e.g., integrated automated underwriting service) to undergo the approval process, at which point the loan application evaluation/status module 36 is configured to provide a status of any given submitted loan application.

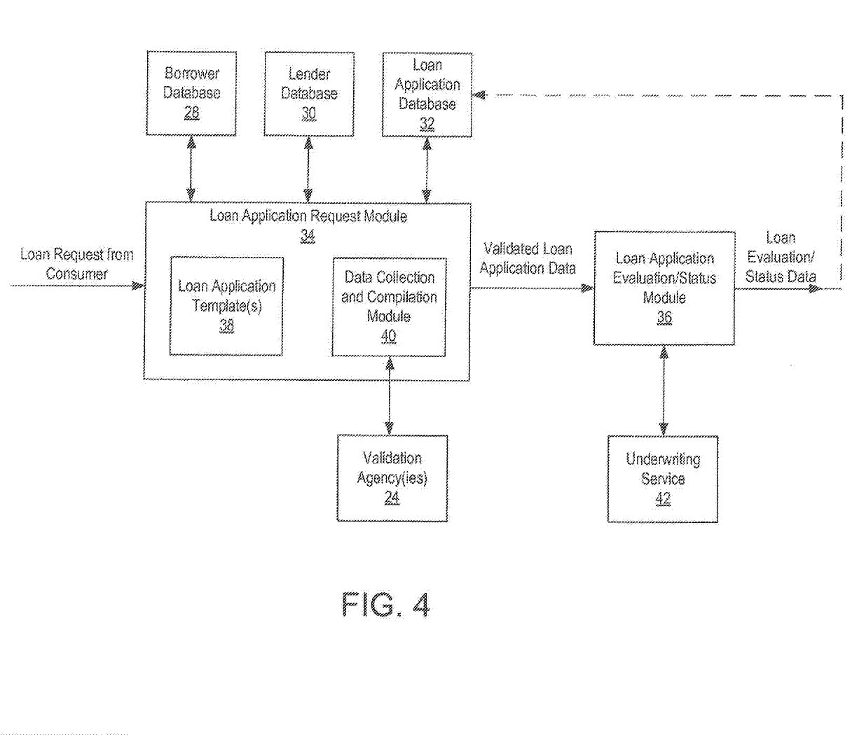

FIG. 4 is a block diagram illustrating an exemplary mortgage loan process from the initial request to begin a loan application through to the submission of the loan application for approval. As shown, the loan application request module 34 may generally include a loan application template module 38 and a data collection and compilation module 40. Via the interface platform 26, a consumer 20 is able to navigate the any options provided by the consumer-facing mortgage process system 14. For example, a consumer may access the system 14 and request a loan application, at which point, the loan application request module is configured to provide an application template 38 based on the request, depending on the type of loan. In the following examples, the loan is a mortgage, thus the loan application template 38 will be associated with a mortgage. However, it should be noted that other types of loans may be contemplates in other lending scenarios, and thus the system 14 is not limited to mortgages. Furthermore, the system is configured to allow the consumer to have access to other services typically handled by the lender 22, including, but not limited to, escrow and closing services, title companies, appraisal companies, insurance agencies, and the like. As such, a system consistent with the present disclosure may provide a marketplace whereby borrowers can select all their own services, in addition to driving the mortgage process.

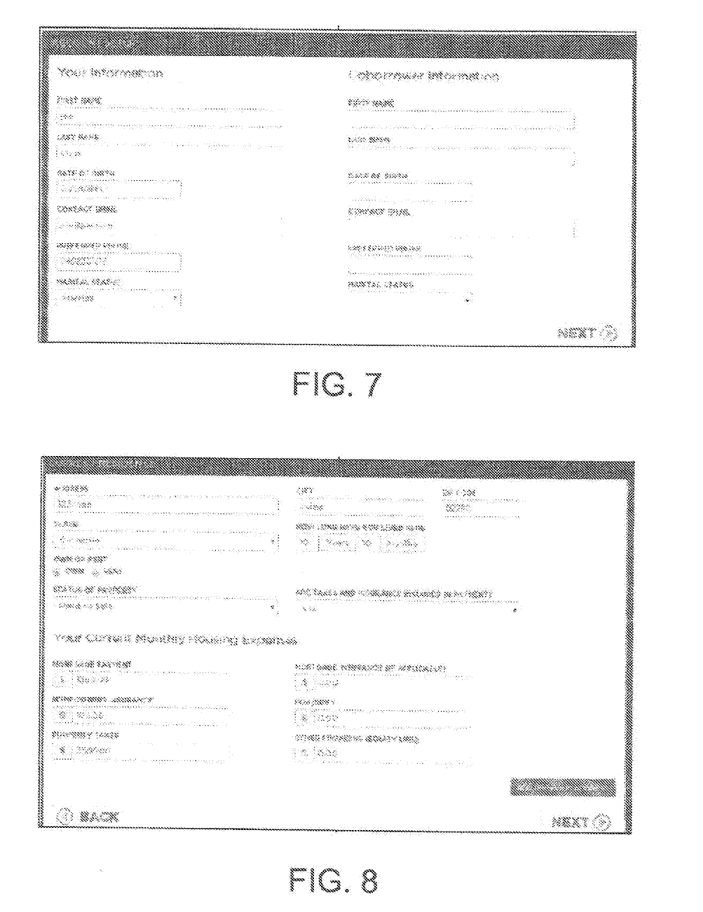

The data collection and compilation module 40 is configured to provide an intuitive data collection process, in which the consumer 20 is walked through the different aspects of the loan application process via the interface 26 (shown in FIGS. 7-12). For example, based on the application template 38, different types of data may be required for the loan processing when applying for a mortgage, including, but not limited to, personal information (name, date of birth, social security number, address, basic information to verify identity, etc.), income, assets, employment information, details related to the property to be purchased or the current property to be refinanced, and additional information as required. Accordingly, the consumer 20 is generally prompted in each step to provide informational data, at which point, the data collection and compilation module 40 is configured to receive the consumer data, either manually entered by the consumer 20 or collected from an associated profile 29 from the borrower database 28, for example. It should be noted that once a new loan application is initiated, a corresponding application 33 is created and stored within the loan application database 32. Accordingly, the data collection and compilation module 40 is configured to continually update the application 33 with data as it is collected, such that a consumer 20 can save the application at any point and request that application at a later point in time to continue working on it

The loan application request module 34 includes certain measure to ensure that certain data provided by the consumer 20 is accurate and verified prior to submission of the application to any pricing and/or underwriting services. For example, in some embodiments, the data collection and compilation module 40 is configured to recognize certain critical data inputs, either based on specifically tagged data fields within the application, or by other means. Certain types of data may be considered critical and may require validation due to the nature of the information. For example, a consumer's identity would be one such critical set of data that requires validation so as to prevent identity fraud. Similarly, one's income should be verified so as to prevent loan fraud. Accordingly, the system 14 is configured to utilize services provided by validation agencies 24 in order to validate data.

For example, a consumer's current address can be verified by the United States Postal Service (USPS), specifically an address information application programming interface (API) integrated into the system, such as USPS Web Tools® Address information API. The details related the current property owned or related to the property to be purchased can be verified by a real estate API, such as one offered by Zillow, for example. The details may include, among other things, the estimated value of the property, which a consumer may rely on when deciding the mortgage amount. Similarly, a consumers income and employment information (e.g., W-2s, and statements, etc.) may be verified by any known methods, most commonly the Income Verification Express Service program provided by the IRS. The system 14 may be configured to securely store return data from the IRS and compare such return data with the income and/or employment data so as to verify that the consumer 20 inputted data matches and can be verified.

Upon receiving all of the required information from the consumer, the loan application request module 34 may further be configured to run a full credit report, generally by utilizing the credit reporting services of common national consumer credit reporting agencies (e.g., Experian, Equifax, and TransUnion). The consumer is able to obtain their credit report and credit scores immediately, with little or no delay, as opposed to the conventional method in which the credit score would be sent (by mail or email) to the consumer from the lender. In the credit pulling process, the consumer 20 is generally pulling their own credit. However, for security purposes, express permission may have to be given by the consumer 20 for this process. The express permission may be in the form of a simple disclosure telling the consumer 20 that credit is about to be pulled, and the consumer 20 may simply have to acknowledge the disclosure and provide permission by checking a box indicating permission is granted, all of which can be provided via the interface 26. After credit is pulled, the liabilities will automatically be exported into the system 14 and associated with the borrower's profile 29. Once the credit is pulled, the consumer 20 can be provided with an overview of their credit report, including their median credit score.

With the credit history and median credit score, the loan application request module 34 may further be configured to utilize an integrated pricing service to calculate and generate various rates, prices, term options based on the various information provided in the application and the consumer's credit report. The consumer 20 will be provided, via the interface 26, loan pricing options from which to choose for their mortgage. This will include different mortgage terms (15 year fixed, 30 year fixed, etc.), associated interest rates, and other information, such as the estimated monthly payment. At this point, consumer 20 has clear visibility as to all available options of the mortgage they are seeking and is able to review all of the parameters of each loan option and select which one is best suited for their situation.

When ready, the consumer 20 has the option of submitting the complete and validated loan application for approval. The loan application evaluation/status module 36 is configured to receive the validated loan application data, consumer's credit report, as well as the selected mortgage pricing option and further transmit such information to an integrated automated underwriting service, such as Fannie Mae's Desktop Underwriter (DU), upon with a loan evaluation/status can be provided to the consumer 20, in addition to updating the associated loan application 33 stored in the database 32. The loan underwriting process may be very quick (e.g., a few seconds) to complete. For example, although most of the mortgage process is carried out from the consumer's perspective, the system 14 of the present invention may utilize services on the lender's end. For example, from a lender's perspective, the system 14 is configured to generate and transmit a rile containing all information associated with the submitted loan application (e.g., a complete and validated loan application) into a loan originating service associated with the lender 22. At which point, conditions may be automatically populated in the loan originating service allowing the underwriter to review the application and provide approval or disapproval. In the event that the loan application comes back with an approval, the consumer 20 may be provided with a list of conditions and the locked in rate, program, and product previously selected.

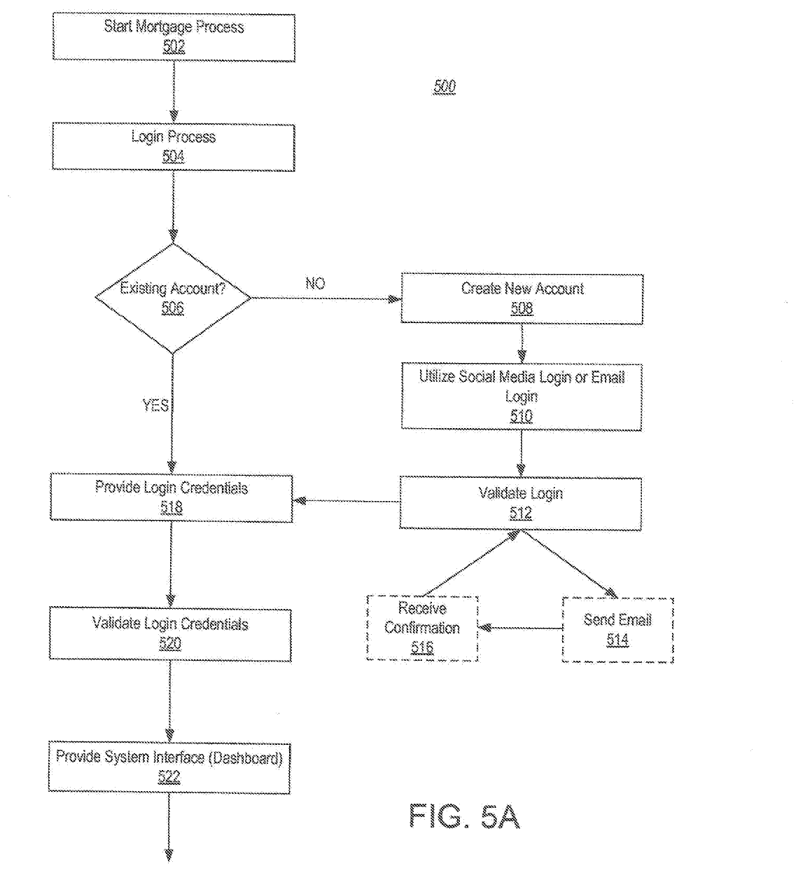

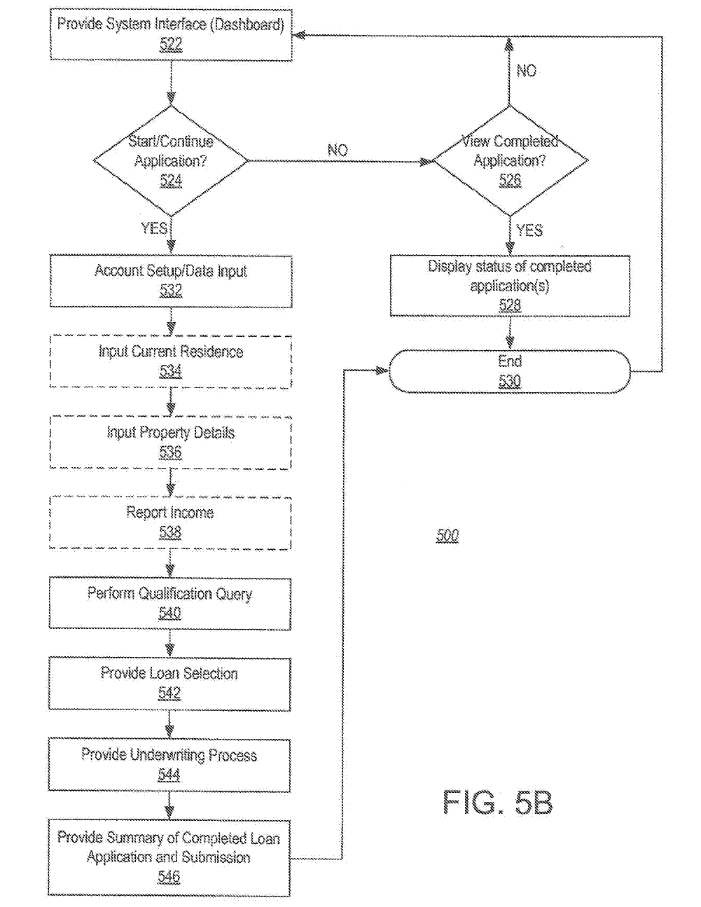

FIGS. 5A and 5B are a continuous flowchart of example operations consistent with at least one embodiment of the present disclosure. In operation 502, a mortgage application process may be initiated. As previously described, the automated consumer-facing mortgage processing system 14 is configured to provide a platform or interface in which a consumer 20 interact and control most of the mortgage process from the front end to the back end. As generally understood, the platform or interface is generally in the form of an interface (e.g., but not limited to graphical user interface (GUI)) provided on a computing device through which a consumer may interact with the system 14, such as accessing and interacting with the mortgage loan process provided by the system 14.

Upon accessing the system 14, which may be embodied on a cloud-based service 12, for example, the consumer is presented with a login process 504. A determination may then be made in operation 506 as to whether the consumer has an existing account with the system. Accordingly, at this point, the consumer may be presented with the option to either sign in to an existing account or create a new account.

FIG. 6 is a screenshot of a home screen dashboard 100 provided by the system interface 26 from which a consumer 20 may navigate various options related to a new or existing mortgage loan application. The dashboard may provide various tools (e.g., 102-108) allowing a consumer 20 to navigate the dashboard and obtain desired information. For example, selection of input 102 allows a consumer 20 to view the current status of a submitted loan application, while selection of input 104 directs the consumer 20 to a page configured to receive and upload documents that may be conditions for their approval directly through the system 14. Selection of input 106 may direct the consumer 20 to a contact page for providing contact information for a member of the lender 22 assigned to the particular mortgage loan application. Selection of input 108 may direct the consumer 20 to a page related to their own account (e.g., borrower profile 29), at which point the consumer 20 may edit account information and/or preferences.

If it is determined in operation 506 that a consumer does not have an existing account, a new account creation process 508 may follow. In order to create a new account, a consumer may be prompted with a specific set of account creation and validation procedures. For example, the system 14 may allow a consumer to use either an existing account from other internet-based platforms (e.g., FACEBOOK, GOOGLE, etc.) or an email address. Accordingly, in operation 510, the consumer may provide an existing account login or email login and the login is then validated in operation 512 so as to ensure the identity of the consumer (validate that the consumer is in fact who they claim to be). The validation process may include, for example, sending a validation email (operation 514) to the email address registered with the internet-based account or simply provided by the consumer. The validation process may further include receiving a confirmation reply email from email address (operation 516), at which point the system 14 is configured to validate the newly created account login and allow subsequent login to the account.

If it is determined in operation 506 that a consumer does have an existing account (or has just created a new account that has since been validated), the consumer is prompted to provide the login credentials in operation 518. This could include providing the username and password (as well as providing answers to hint-based questions that the consumer may have previously set up). The system 14 is configured to validate the login credentials in operation 520 by any known means (e.g., custom, proprietary, known and/or after-developed validation code or instruction sets), hardware, and/or firmware that are generally well-defined and operable to receive and verify user credentials with previously stored accounts).

Upon validating the consumer's login credentials, the system 14 redirects the consumer to a dashboard in operation 522. The dashboard, or home screen, generally provides the consumer with the ability to navigate various options related to new or existing mortgage loan application (see screenshot of FIG. 6). As shown in FIG. 5B, for example, a consumer may either start a new application, continue working on an existing application that was previously saved, or view a completed application.

Accordingly, a determination may then be made in operation 524 as to whether the consumer would like to start/continue a mortgage loan application. If it is determined in operation 524 that the consumer does not want to start/continue an application, then a determination may then be made in operation 526 as to whether the consumer would like to view a completed application. A completed application may be understood to refer to a loan application that has been completed and since submitted for approval. If it is determined in operation 526 that the consumer does not want to view a completed application, then operation may repeat and the consumer may be presented with the dashboard. If it is determined in operation 526 that the consumer does wish to view a completed application (e.g., consumer selects tool for viewing a particular completed and submitted application), the system 14 is configured to display the current status of the completed application in operation 528. The status of the application may include informational data related to the submission and approval process of the application, including, but not limited to, date of submission, progress of the approval of the loan application, stages of the approval process, current stage of the approval process, any information required to further progress and move loan application through any remaining stages of approval process, estimated time remaining until final approval, and the like.

Upon viewing the status of a completed application in operation 528, the consumer may then terminate the status display screen of the interface (either exiting from the status display screen or entirely logging out of their account) such that, in operation 530, viewing of a completed application may be terminated. At this point, operation 522 may repeat and the consumer may be presented with the dashboard in operation 522, at which point they can then either start a new application, continue working on an existing application that was previously saved, or view a completed application.

If it is determined in operation 524 that the consumer does want to start/continue an application, the system 14 is configured to provide the consumer with options for either viewing an existing application that is currently in progress (has not been submitted for approval) or an option to start a new application. In each scenario, the system 14 is configured to prompt the consumer for data required to complete the loan mortgage process (e.g., provide different screens eliciting specific information). For example, in operation 532, a consumer may be prompted to set up an account or verify account information. Accordingly, in the event that the consumer wants to start a new loan application, the system 14 is configured to collect various sets of data from the consumer. For example, the consumer may be prompted to setup an account in operation 532, in which the consumer provides conventional input (e.g., name, address, date of birth, social security number, contact information such as email and preferred phone number, billing information, background information, preferences, login credentials, etc.). In the event that there will be a co-borrower for the loan, the co-borrower's information is also provided. An exemplary screenshot of an interface prompting the account setup information is shown in FIG. 7, for example.

Upon the consumer entering (or confirming) account information, the system 14 is configured to direct the consumer through the mortgage loan process in a step-by-step manner. For example, in operation 534, the consumer may be prompted to provide data associated with their current residence. The data may include, but is not limited to, address, length of time in which consumer has lived there, the current status of the property (e.g., not for sale, pending sale, etc.), tax information, insurance information, current monthly housing expenses, and the like. An exemplary screenshot of an interface prompting the consumer for information regarding their current residence is shown in FIG. 8, for example. As previously described, the system 14 includes measures to ensure that certain data provided by the consumer is accurate. Accordingly, in operation 534, a consumer's current address can be verified by the United States Postal Service (USPS), specifically an address information application programming interface (API) integrated into the system, such as USPS Web Tools® Address information API.

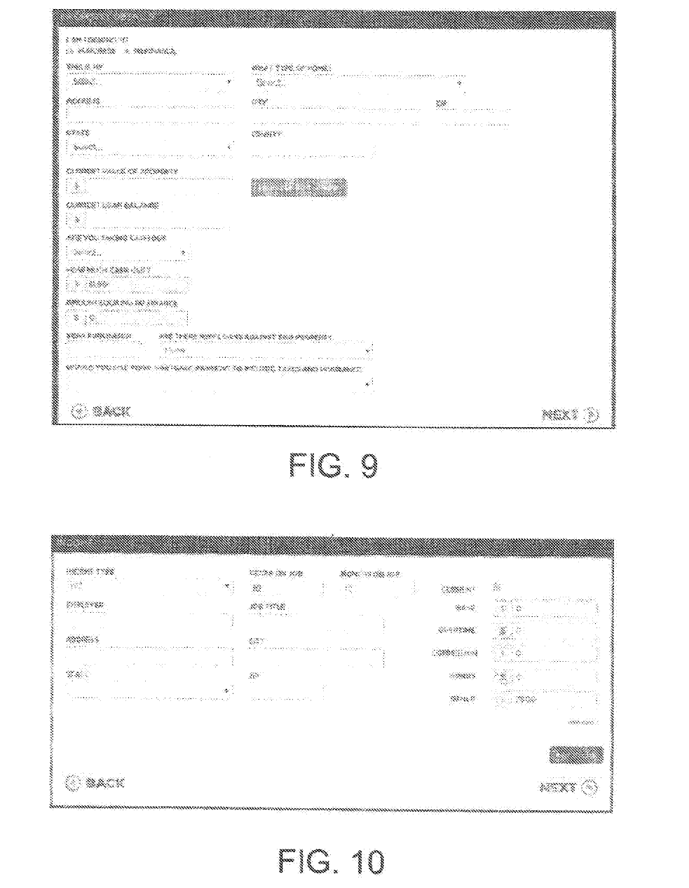

In operation 536, the consumer may be prompted to provide data associated with the property to be purchased or their current property that they may wish to refinance. The data may include a selection input indicating whether the loan is to be for a purchase or refinance. The data may further include, but is not limited to, the type or property (single family, condo/townhome, multifamily, etc.), address, price (or value) of property, current loan balance (in the event that the loan is for a refinance), down payment amount, amount seeking to finance, and the like. An exemplary screenshot of an interface prompting the consumer for information regarding their current residence is shown in FIG. 9, for example. Similar to verification of the residence address, the data associated with the property to be purchased/refinanced of operation 536 can be verified by a real estate API, such as one offered by Zillow, for example. The details may include, among other things, the estimated value of the property, which a consumer may rely on when deciding the mortgage amount.

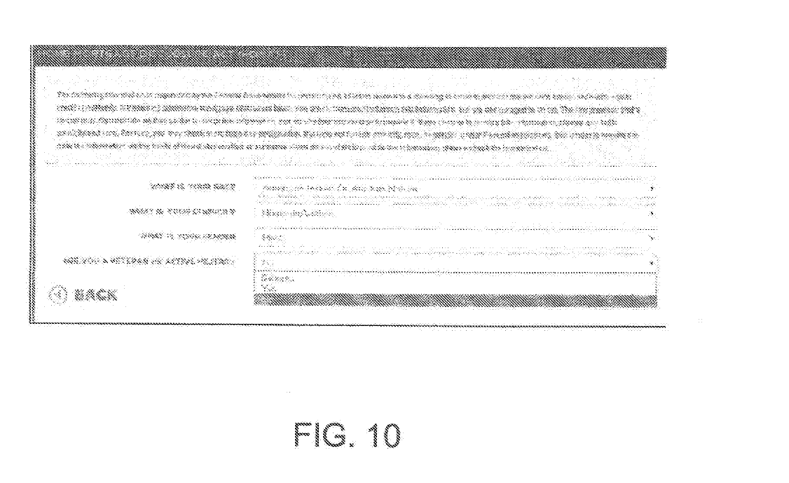

In operation 538, the consumer may be prompted to provide data associated with their income and/or employment. The data may include, but is not limited to, employer, employer information, length of employment, income or wages derived from employment, and the like. An exemplary screenshot of an interface prompting the consumer for income/employment information is shown in FIG. 10, for example. Similarly, a consumer's income and employment information (e.g., W-2s, bank statements, etc.) may be verified by any known methods, most commonly the Income Verification Express Service program provided by the IRS.

It should be noted that the system 14 is configured to provide various disclosure documents to the consumer as required during the mortgage loan process, specifically as required by the Home Mortgage Disclosure Act (HDMA). Furthermore, the system 14 may further collect information as federally required during a mortgage loan process. An exemplary screenshot of an interface prompting the consumer for various information is shown in FIG. 10, for example.

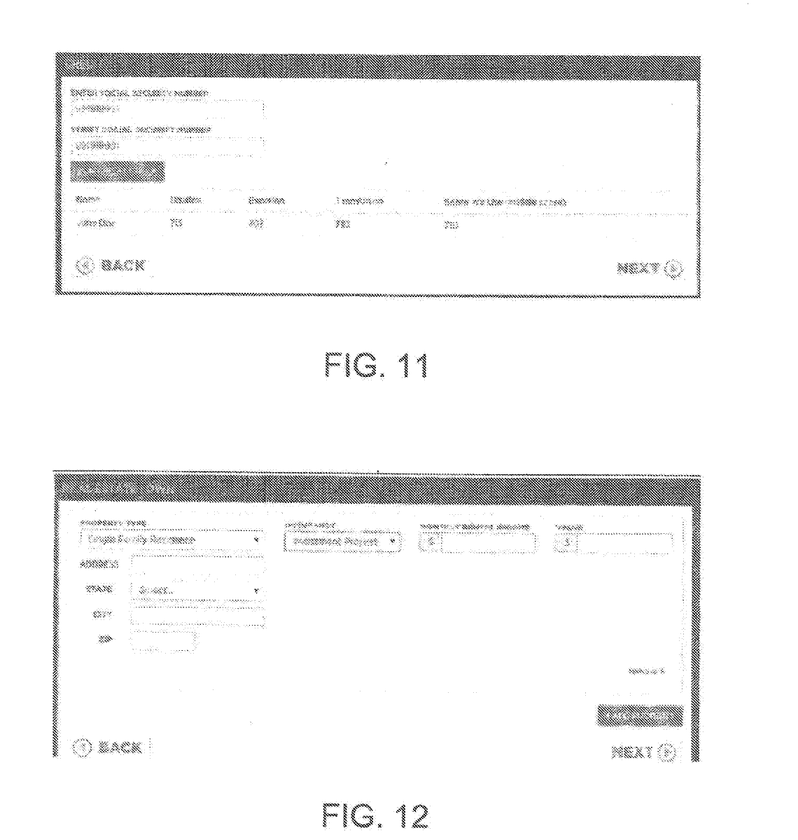

In addition to providing various information (current residence, prospective property, income, etc.), the system 14 further configured to provide the consumer with the ability to run a full credit report, which will be relied upon during the subsequent qualification query in operation 540. As shown in FIG. 11, the consumer is prompted for at least their social security number in order to verify their identity and receive a credit report. The system 14 is configured to utilize credit reporting services of common national consumer credit reporting agencies (e.g., Experian, Equifax, and TransUnion). The consumer is able to obtain their credit report and credit scores immediately, with little or no delay, as opposed to the conventional method in which the credit score would be sent (by mail or email) to the consumer from the lender. In the credit pulling process, the consumer is generally pulling their own credit. Once the credit is pulled, the consumer is provided with an overview of their credit report, including their median credit score, which will subsequently be used in the qualification process.

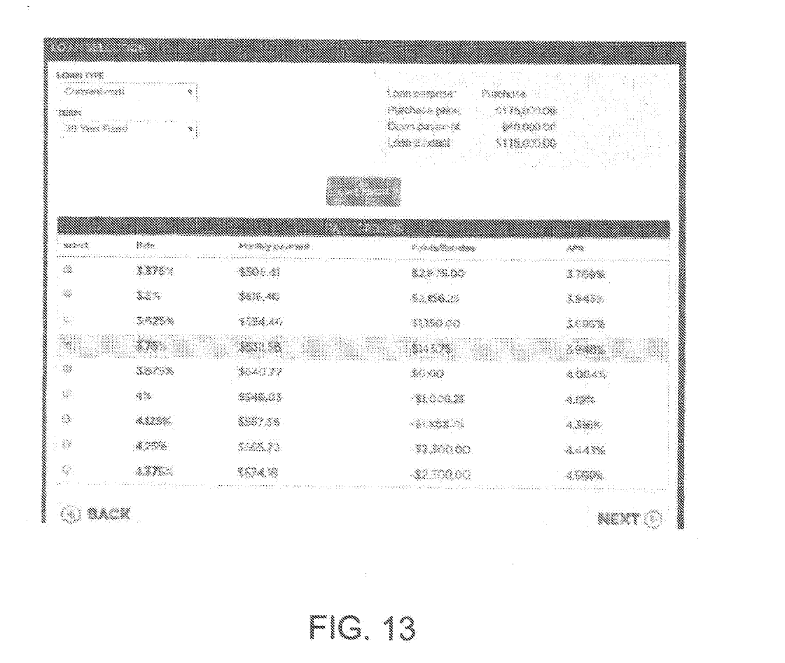

Upon collection all of the required information from the consumer in operations 534-538, as well as obtaining a credit report and other information related to consumer assets and the like (see FIG. 12), the system 14 is configured to perform a qualification query in operation 540. As part of the qualification query, crucial information obtained in operations 534-538 (e.g., consumer income, information related to property to be purchased/refinanced, credit history and credit score, etc.) is analyzed using an integrated pricing service configured to calculate and generate various rates, prices, term options. Upon processing such information and using a pricing service, a loan selection interface is provided to the consumer in operation 542. An exemplary screenshot of an interface providing loan options to the consumer is shown in FIG. 13, for example. The system 14 is configured to provide loan pricing options directly to the consumer, such that the consumer has clear visibility as to all available options of the mortgage they are seeking. At this point, the consumer is able to review all of the parameters of each loan option and select which one is best suited for their situation.

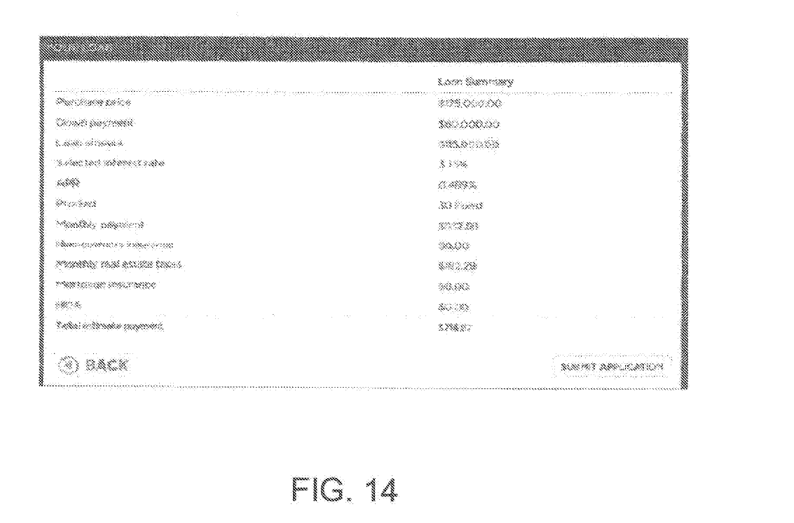

Upon selecting the loan option, the consumer is able to then review their application and further has the option of submitting the complete and validated loan application for the underwriting process for approval in operation 544. An exemplary screenshot of an interface providing an overview of the consumer's loan selection and associated information is shown in FIG. 14, for example. Upon submission, the validated loan application data, consumer's credit report, as well as the selected mortgage pricing option may be transmitted to an integrated automated underwriting service, such as Fannie Mae's Desktop Underwriter (DU). Similarly, in operation 546, the completed loan application and submission thereof can be provided to the consumer. The consumer may then terminate the status display screen of the interface (either exiting from the status display screen or entirely logging out of their account) such that, in operation 530, viewing of a completed application may be terminated. At this point, operation 522 may repeat and the consumer may be presented with the dashboard in operation 522, at which point they can then either start a new application, continue working on an existing application that was previously saved, or view a completed application.

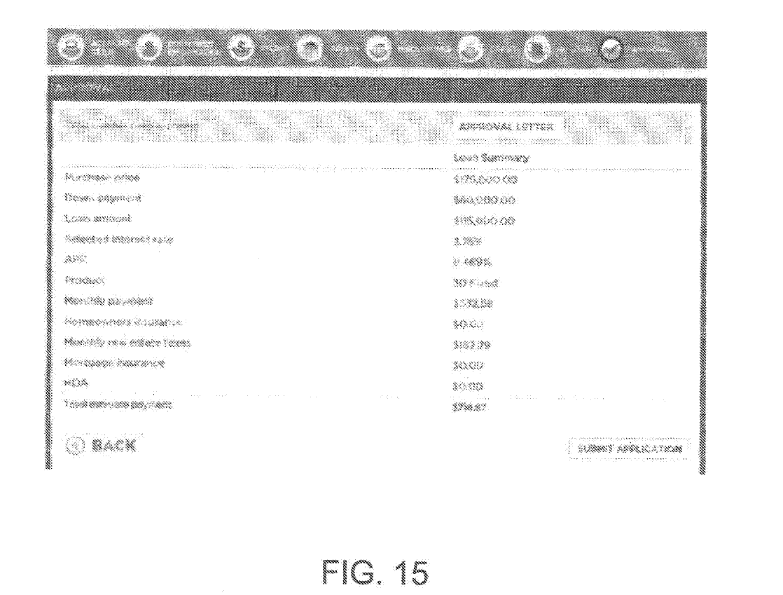

In the event that a loan application is approved, the consumer may be provided with an approval notice (e.g., contacted via email or other preferred method). FIG. 15 is a screenshot of the interface provided by the system illustrating an overview of an approved mortgage loan summarizing the more common and relevant terms of the mortgage loan.

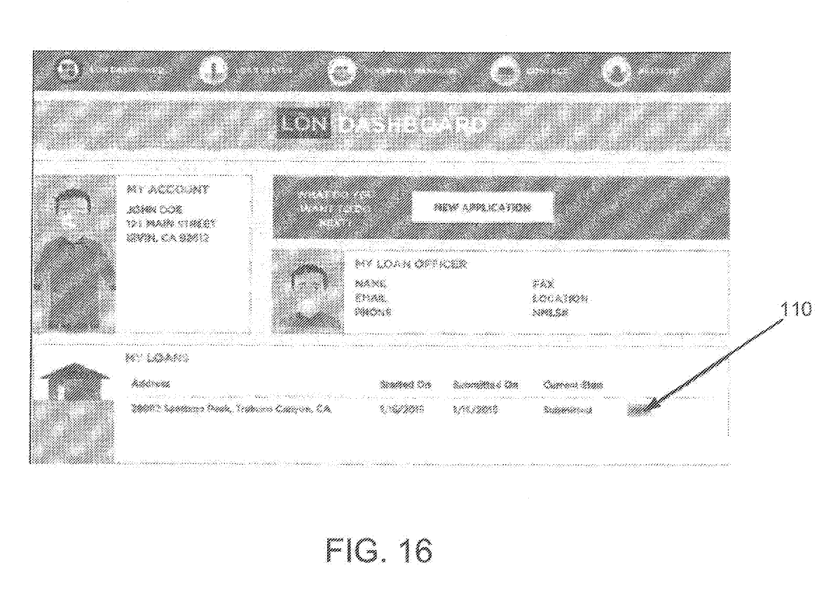

FIG. 16 is a screenshot of the home screen dashboard provided by the system interface illustrating the ability of a consumer to view particular aspects of an existing mortgage loan application.

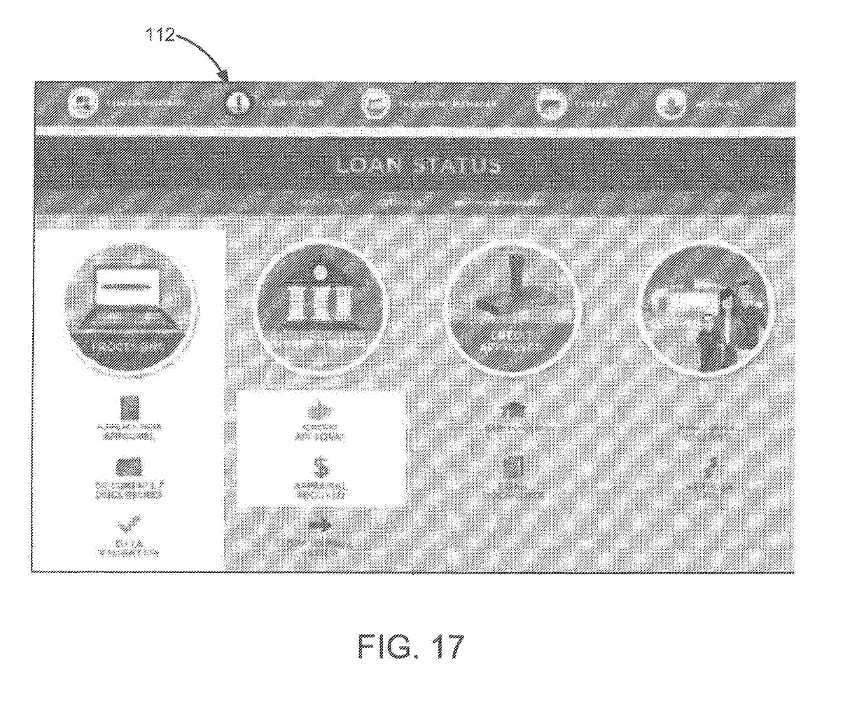

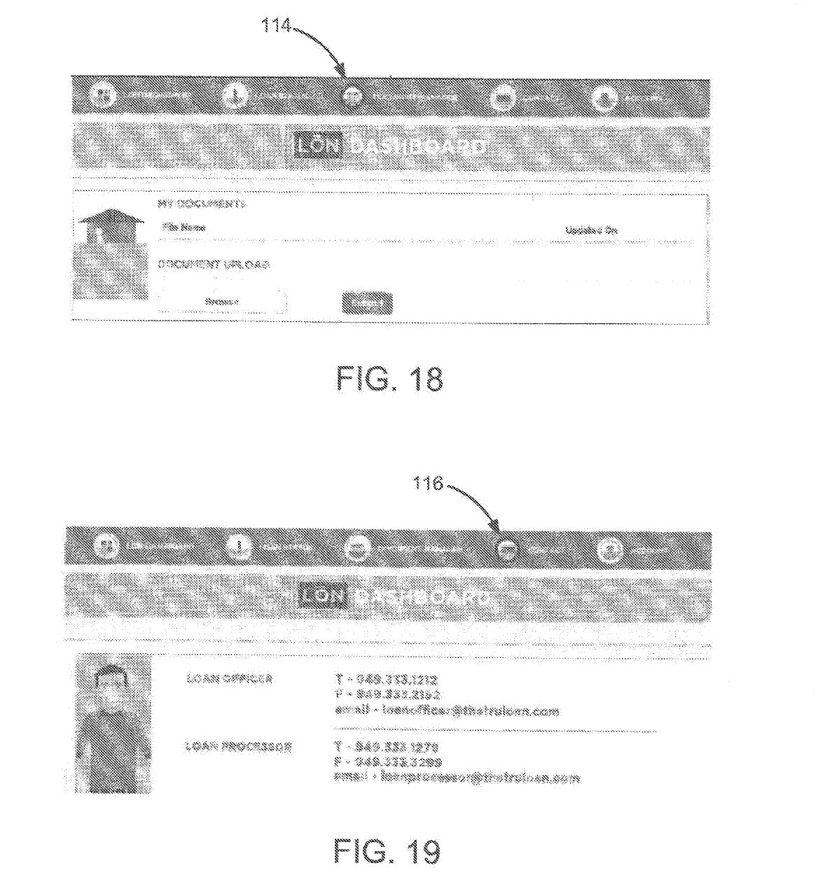

FIGS. 17-19 are screenshots of the dashboard illustrating various options related to viewing the particular aspects of an existing mortgage loan application, including the status of the application, document management providing upload capabilities, and a contact page for providing contact information for a member of the lender assigned to the particular mortgage loan application.

While FIGS. 5A and 5B illustrate various operations according to an embodiment, it is to be understood that not all of the operations depicted in FIGS. 5A and 5B are necessary for other embodiments. Indeed, it is fully contemplated herein that in other embodiments of the present disclosure, the operations depicted in FIGS. 5A and 5B and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

While several embodiments of the present disclosure have been described and illustrated herein, those of ordinary skill in the art will readily envision a variety of other means and/or structures for performing the functions end/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, haired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value failing within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” the and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limiter in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, Intel Core i& Extreme Edition 980X, or Intel Xeon E7-2820).

An I/O mechanism may include a video display unit (e.g., a liquid crystal display (LCD) or a cathode ray tube (CRT)), an alphanumeric input device (e.g., a keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A fully automated consumer-facing loan processing platform comprising:
a network-based computing system configured to communicate and exchange data with one or more network access computing devices via a communications network, the network-based computing system comprises:
an interface configured to provide visual representation of data associated with a loan request and application process to the one or more network access computing devices and further receive input data from a user associated with one of the network access computing devices to thereby allow the user to interact with and direct the loan request and application process;
a first memory for storing input data received from the interface and associated with the user, the input data comprises information related to at least one of user background and credentials, user income and assets, user credit, property to be associated with the loan, and a combination thereof;
a second memory for storing one or more loan request applications generated by a processor in response to input data; and
at least a processor configured to generate a loan request application based on the input data, verify the validity of the input data, and output one or more loan scenarios to be presented to the user is the interface, wherein the user is pre-approved for the one or more loan scenarios.

2. The platform of claim 1, further comprising an underwriting service configured to receive, from the at least a processor, the loan request application, the associated validated input data, and a selected loan scenario and further analyze the loan request application, the associated validated input data, and a selected loan scenario for approval.

3. The platform of claim 2, wherein the at least a processor is configured to output data related to the approval process of the underwriting service to be presented to the user via the interface.

4. The platform of claim 3, wherein the approval process data is selected from the group consisting of: status of the loan request application, date of submission of the loan request application, estimated date of approval, progress of the approval process, stages of the approval process, current state of the approval process, additional information required to progress loan request application through the approval process, and a combination thereof.

5. The platform of claim 1, further comprising a pricing service configured to receive, from the processor, the validated input data of the loan request application and further analyze the validated input data to generate the one or more loan scenarios.

6. The platform of claim 1, wherein the one or more loan scenarios comprises information related to loan terms selected from the group consisting of: loan term, loan type, interest rate, estimated monthly payments, points/rebates, annual percentage rate (APR), and a combination thereof.

7. The platform of claim 1, wherein the at least a processor is configured to compare the input data with verified data from a third-party service to thereby verify the validity of the input data.

8. The platform of claim 7, wherein the third-party service comprises an application programming interface associated with verified data selected from the group consisting of addresses, real estate listings, user income and employment, and a combination thereof.

9. An improved computer-implemented process for providing an automated consumer facing loan application process, the process comprising executing on a processor the steps of:
receiving, via an interface, a request and input data from a user for a loan application;
receiving and storing, via a first memory, input data associated with the user, the input data comprises information related to at least one of user background and credentials, user income and assets, user credit, property to be associated with the loan, and a combination thereof;
generating, via a processor, a loan request application based on the input data;
verifying, via the processor, the validity of the input data; and
outputting, via a communications network, one or more loan scenarios to be presented to the user via the interface and associated with one or more network access computing devices, wherein the user is pre-approved for the one or more loan scenarios.

10. The process of claim 9, wherein the interface is configured to provide visual representation of data associated with the loan request and application process to the one or more network access computing devices and further receive input data from a user associated with one of the network access computing devices to thereby allow the user to interact with and direct the loan request and application process.

11. The process of claim 9, further comprising:
receiving, via an underwriting service, the loan request application, the associated validated input data, and a selected loan scenario; and
analyzing, via the underwriting service, the loan request application, the associated validated input data, and a selected loan scenario for approval of the loan request.

12. The process of claim 11, further comprising outputting, via the processor, data related to the approval process of the underwriting service to be presented to the user via the interface.

13. The process of claim 12, wherein the approval process data is selected from the group consisting of: status of the loan request application, date of submission of the loan request application, estimated date of approval, progress of the approval process, stages of the approval process, current state of the approval process, additional information required to progress loan request application through the approval process and a combination thereof.

14. The process of claim 9, further comprising:
receiving, via a pricing service, the validated input data of the loan request application; and
analyzing, via the pricing service, the validated input data to generate the one or more loan scenarios.

15. The process of claim 9, wherein the one or more loan scenarios comprises information related to loan terms selected from the croup consisting of: loan term, loan type, interest rate, estimated monthly payments, points/rebates, annual percentage rate (APR), and a combination thereof.

16. The process of claim 9, further comprising comparing, via the processor, the input data with verified data from a third-party service to thereby verify the validity of the input data.

17. The process of claim 16, wherein the third-party service comprises an application programming interface associated with verified data selected from the group consisting of addresses, real estate listings, user income and employment, and a combination thereof.

18. Products by any step of the processes of claims 9-17, further comprising tangible manifestations in written, electronic or other formats.

19. Products, by any process described herein, displayed on personal digital assistants or general purpose computers.

20. A non-transitory computer-readable medium for providing an automated consumer-facing loan application process, the medium comprising instructions stored thereon, that when executed on a processor, perform the steps of:
receiving a request and input data from a user for a loan application;
receiving and storing input data associated with the user, the input data comprises information related to at least one of user background and credentials, user income and assets, user credit, property to be associated with the loan, and a combination thereof;
generating a loan request application based on the input data;
verifying the validity of the input data; and
outputting one or more loan scenarios to be presented to the user via an interface associated with one or more network access computing devices, wherein the user is pre-approved for the one or more loan scenarios.

21. The non-transitory computer-readable medium of claim 20, further comprising presenting a visual representation of data associated with the loan request and application process to the user via the one or more network access computing device and allowing the user to interact with and direct the loan request and application process.

22. The non-transitory computer-readable medium of claim 20, further comprising:
receiving and analyzing the loan request application, the associated validated input data, and a selected loan scenario for approval of the loan request.

23. The non-transitory computer-readable medium of claims 21 or 22, further comprising outputting data related to the approval process of the underwriting service to be presented to the user via the interface.

24. The non-transitory computer-readable medium of claim 23, wherein the approval process data is selected from the group consisting of: status of the loan request application, date of submission of the loan request application, estimated date of approval, progress of the approval process, stages of the approval process, current state of the approval process, additional information required to progress loan request application through the approval process, and a combination thereof.

25. The non-transitory computer-readable medium of claim 20, further comprising:
receiving and analyzing the validated input data of the loan request application to generate the one or more loan scenarios.

26. The non-transitory computer-readable medium of claim 20, wherein the one or more loan scenarios comprises information related to loan terms selected from the group consisting of: loan term, loan type, interest rate, estimated monthly payments, points/rebates, annual percentage rate (APR), and a combination thereof.

27. The non-transitory computer-readable medium of claim 20, further comprising comparing the input data with verified data from a third-party service to thereby verify the validity of the input data.

28. The non-transitory computer-readable medium of claim 26, wherein the third-party service comprises an application programming interface associated with verified data selected from the group consisting of addresses, real estate listings, user income and employment, and a combination thereof.
